(19) United States
(12) Patent Application Publication
(10) Pub. No.: US 2013/0343748 A1
(43) Pub. Date: Dec. 26, 2013

(54) APPARATUS AND METHOD FOR MONITORING OPTICAL SIGNAL TRANSMISSION IN OPTICAL FIBERS

(71) Applicant: Conolog Corporation, (US)

(72) Inventors: Marc Benou, Westfield, NJ (US); Ilya Kovnatsky, Holland, PA (US)

(73) Assignee: CONOLOG CORPORATION, Somerville, NJ (US)

(21) Appl. No.: 13/792,313

(22) Filed: Mar. 11, 2013

Related U.S. Application Data
(60) Provisional application No. 61/650,629, filed on May 23, 2012.

(51) Int. Cl. H04B 10/079

(52) U.S. Cl. CPC H04B 10/07957
USPC 398/29

(57) ABSTRACT

An apparatus for monitoring optical signal transmission in a plurality of optical fibers may include a fixture for introducing a bend into the plurality of fibers arranged at respective predetermined locations on the fixture, to cause a portion of light propagating in any of the fibers to scatter out therefrom. The apparatus may include a lens unit positioned to focus the scattered light onto predetermined photo-detectors of an array, in accordance with the fiber from which the scattered light emanates, and generate image data indicating a characteristic of the scattered light detected at respective ones of the photo-detectors identified by location in the array corresponding to the respective ones of the photo-detectors.

### CROSS REFERENCE TO RELATED APPLICATIONS

The present application claims priority from U.S. Provisional Application No. 61/650,629 filed May 23, 2012, the disclosure of which is hereby incorporated herein by reference.

### FIELD

The present disclosure relates to detection of optical energy in an optical fiber, and more particularly, non-invasively determining whether an optical signal is being conveyed in optical fibers of an optical fiber ribbon.

### BACKGROUND

In the prior art, devices may non-invasively determine whether an optical signal is being conveyed in an optical fiber, based on detection of optical energy escaping out from the optical fiber when the optical fiber is arranged in a bent configuration.

In a typical communications network, a large number of optical fibers may be used to interconnect optical network terminals (ONTs), which are typically located at a residential home or business office, and head end units (“head ends”), such as a content server or other types of data distribution servers, located remotely from the ONTs. For example, a communications network may be configured as a Passive Optical Network (PON) including a fiber distribution hub (FDH) which, on an upstream side is coupled to a head end by a single optical fiber, and on a downstream side is coupled to a plurality of optical fibber ribbons. The ribbons each include a plurality of optical fibers, and the fibers of the ribbons are coupled through optical splitters in the FDH to the single fiber from the head end. The optical fiber ribbons, at a downstream side, are connected to a routing panel unit. The panel unit is configured so that individual optical fibers (commonly known as fiber-to-the-home or “FTTH fibers”), which at a downstream side are for connection to respective ONTs, may be coupled to respective fibers of the ribbons.

Oftentimes, in a PON communication network, the identity of an optical fiber of the optical ribbons at the panel unit that is connected with a particular ONT via a FTTH fiber is unknown, or information concerning correspondence between ONTs and fibers of the ribbons connected thereto is incorrect. For example, documentation concerning connections between fibers of the ribbons and respective ONTs may not exist, or the information available may be incorrect due to errors by technicians who incorrectly connect a first fiber of an optical fiber ribbon at the panel unit to a particular ONT instead of a second fiber of the ribbon which is actually intended to be connected to the particular ONT and is indicated in connection documentation as being connected to the particular ONT. In the absence of information that reliably identifies the optical fibers of the optical fiber ribbons at the panel unit that are connected to respective ONTs, response to and repair of communication service problems reported as occurring for an ONT in a PON may be difficult, especially where a large number of optical fiber connections exist between fibers of the fiber ribbons at the panel unit and respective ONTs.

Therefore, a need exists for apparatus, method and system for non-invasively monitoring optical signal transmission of a plurality of optical fibers to permit determination of a connection arrangement between the fibers and respective optical communication units in an optical communication network reliably and with ease.

### SUMMARY

In accordance with an embodiment of the present disclosure, an apparatus for monitoring optical signal transmission in a plurality of optical fibers, the apparatus may include a fixture for introducing a bend into the plurality of fibers arranged at respective predetermined locations on the fixture, to cause a portion of light propagating in any of the fibers to scatter out therefrom; and an imaging assembly including a lens unit and an imaging unit containing an array of photo-detectors. The lens unit may be positioned to focus the scattered light onto predetermined photo-detectors of the array, in accordance with the fiber from which the scattered light emanates, and the imaging unit may generate image data indicating a characteristic of the scattered light detected at respective ones of the photo-detectors identified by location in the array corresponding to the respective ones of the photo-detectors.

In accordance with an embodiment of the present disclosure, a method for monitoring optical signal transmission in a plurality of optical fibers may include introducing a bend into the plurality of fibers arranged at respective predetermined locations on a fixture, to cause a portion of light propagating in any of the fibers to scatter out therefrom; focusing the scattered light onto predetermined photo-detectors of an array of photo-detectors, in accordance with the fiber from which the scattered light emanates; and generating image data indicating a characteristic of the scattered light detected at respective ones of the photo-detectors identified by location in the array corresponding to the respective ones of the photo-detectors

### BRIEF DESCRIPTION OF THE DRAWINGS

The features, aspects, and advantages of the present disclosure will become better understood with regard to the following description and accompanying drawings where:

FIG. 1 is a block diagram of an optical communication network in which monitoring of optical signal transmission in optical fibers may be implemented, in accordance with an embodiment of the present disclosure.

FIG. 2 is a block diagram of a monitoring apparatus within a fiber distribution hub, in accordance with an embodiment of the present disclosure.

FIG. 3 is a perspective view of an imaging assembly, in accordance with an embodiment of the present disclosure.

FIG. 4A is a perspective view of the imaging assembly of FIG. 3 at cross-sectional line 4A-4A.

FIG. 4B is a perspective view of the arrangement of selected portions of the imaging assembly of FIG. 3.

FIG. 5 is a perspective view of an optical fiber ribbon fixture of the imaging assembly of FIG. 3 in a ribbon receiving state, in accordance with an embodiment of the present disclosure.

FIG. 6 is perspective view of the optical fiber ribbon fixture of FIG. 5 in a ribbon holding state, in accordance with an embodiment of the present disclosure.

FIG. 7 is a perspective view in the direction of the side of the optical fiber ribbon fixture of FIG. 5 that faces an imaging unit of the imaging assembly of FIG. 3.

FIG. 8A is a perspective view of a portion of the fixture of the imaging assembly of FIG. 3 in a state where an optical fiber ribbon including a plurality of optical fibers is held in a bent configuration by the fixture.

FIG. 8B is a schematic illustration of focusing of light scattering from portions of optical fibers, which are in proximity to cross-sectional line 8B-8B of FIG. 8A, onto photo-detectors of an array, in accordance with an embodiment of the present disclosure.

FIG. 9 is a schematic illustration of a linear array of photo-detectors for detecting light scattering from optical fibers held in a bent configuration, in accordance with an embodiment of the present disclosure.

FIG. 10 is a schematic illustration of a two-dimensional array of photo-detectors for detecting light scattering from optical fibers held in a bent configuration, in accordance with an embodiment of the present disclosure.

FIG. 11 is a schematic illustration of a portion of an optical fiber ribbon extending along the arcuate surface portion of the optical fiber ribbon fixture as shown in FIG. 8A.

FIG. 12 is a block diagram of a fiber connection path identification unit, in accordance with an embodiment of the present disclosure.

FIG. 13 is a flow diagram of a method for determining a connection arrangement between a plurality of fibers and respective ONTs in a communication network, in accordance with an embodiment of the present disclosure.

### DETAILED DESCRIPTION

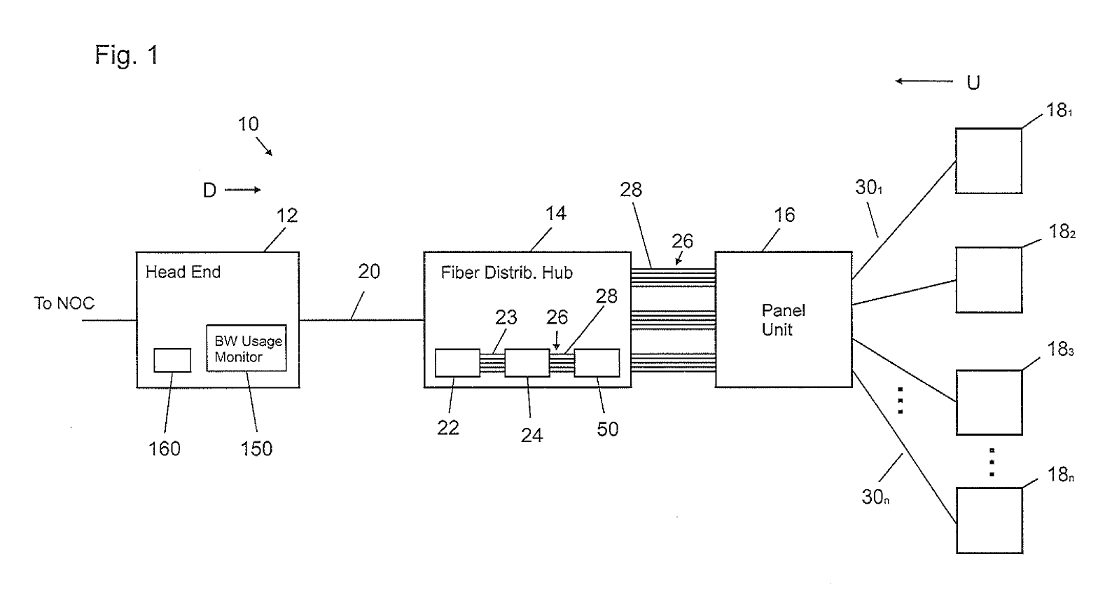

FIG. 1 depicts a high level block diagram of a passive optical network (PON) 10 in which an embodiment of an apparatus, method and system for monitoring optical signal transmission in a plurality of optical fibers may be applied, in accordance with the present disclosure. It is to be understood that the aspects of the present disclosure for monitoring optical signal transmission in a plurality of optical fibers may be implemented in other types of optical networks or like configurations that utilize a plurality of optical fibers for interconnecting optical communication units respectively coupled to one end of the optical fibers, with at least one other optical communication unit coupled to the opposite end of the fibers.

Referring to FIG. 1, the PON 10 may include a head end 12, an optical fiber distribution hub 14, an optical fiber routing panel 16 and a plurality of optical network terminals (ONTs) 18₁ to 18_{N}.

The head end 12 may include optical transceivers for transmitting data, such as content and content related information, and receiving data, such as email and Internet search request information, carried by optical signals. An optical fiber cable 20 may include a single multimode optical fiber that interconnects the head end 12 and the hub 14.

The hub 14 typically does not include electrically powered components, and may include a first beam splitter 22 and a second, post-splitter unit 24. The splitter 22 couples an optical signal supplied from the single fiber of the cable 20 into a plurality of optical fibers 23, such as 16, 32, 64 or 128 fibers 23. The fibers 23 extend from the splitter 22 to the post-splitter unit 24, where groups of the fibers 23 are respectively coupled to optical fibers 28 of respective optical fiber ribbons 26. The fibers 23 and 28 may be a single mode or multimode fiber. Each of the ribbons 26 contains a same number of optical fibers 28 as the number of fibers 23 in the group of fibers 23 from the splitter 22 coupled to the ribbon.

The ribbons 26 interconnect the hub 14 with the routing panel 16. The routing panel 16 may include optical fiber connector jacks (not shown), which on one side are coupled respectively to the fibers 28 of the ribbons 26. The jacks typically are identified at the panel 16 with numbers that correspond respectively to numbers used to identify the fibers 28 of the ribbons 26. For example, if the ribbons 26 connected to the hub 14 include a total of 1048 optical fibers, the jacks are numbered 1 to 1048 and are connected, on a back side thereof, to the fibers 28₁ to 28₁₀₄₈, respectively. The jacks permit interconnection of the optical fibers 28 of the ribbons with respective optical fibers 30, known as fiber-to-the home (FTTH) fibers. The FTTH fibers 30 are, at one end, connected at the front side of the jacks and, at the other end, connected respectively to the ONTs 18.

The ONTs 18 may include optical signal transceivers that receive optical signals transmitted over the PON 10 from the head end 12 and carrying communication data including content data, and transmit to the head end 12 over the PON 10 optical signals carrying communication data, such as email or Internet search request information.

In the PON 10, an optical signal connection path may be established between each ONT 18i and the head end 12, where the connection path extends from the ONT 18i through a fiber 30i, a connector jack interconnecting the fiber 30i with a fiber 28i of the ribbons 26, a fiber 23i coupled to the fiber 28i at the hub 14 and the single fiber of the cable 20. In the event documentation is unavailable or incorrect concerning connection of FTTH fibers 30 respectively to connector jacks at the panel unit 16, actual connection paths between respective ONTs 19 and the fibers 28 in the PON 10 may be unknown.

In accordance with an aspect of the present disclosure, a monitoring apparatus 50 may be provided at the hub 14 and operate to non-invasively detect whether optical signal transmission is occurring through one or more of the optical fibers 28 of the respective ribbons 26 by imaging of the fibers 28 at an array of photo-detectors. Image data may be generated at the array, based on detection of light caused by the monitoring apparatus 50 to escape out of the fibers 28. The image data may be used to determine a connection arrangement that indicates connection paths between respective fibers 28 and ONTs 18, in other words, which fibers 28 are respectively connected to which ONTs 18 in the PON 10. As discussed in detail below, in one embodiment a connection arrangement in the PON 10 between the fibers 28 and respective ONTs 18 may be determined by comparing throughput data for the respective ONTs 18, with data representative of detected optical power levels of light escaping out of the respective fibers 28 indicated by the image data. In a further embodiment, for a predetermined monitoring interval, ratios of average brightness characteristic values representative of the detected optical power levels of the escaping light for respective pairs of the fibers 28, as indicated by the image data, may be compared to ratios of average throughput data levels for respective pairs of ONTs 18, to determine connection arrangements in the PON 10 between the fibers 28 and respective ONTs 18.

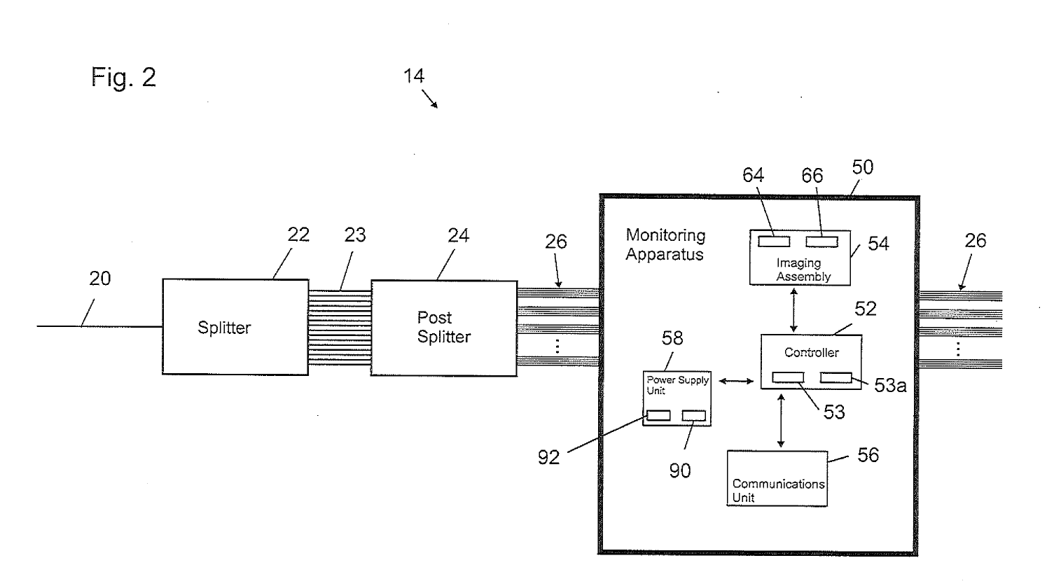

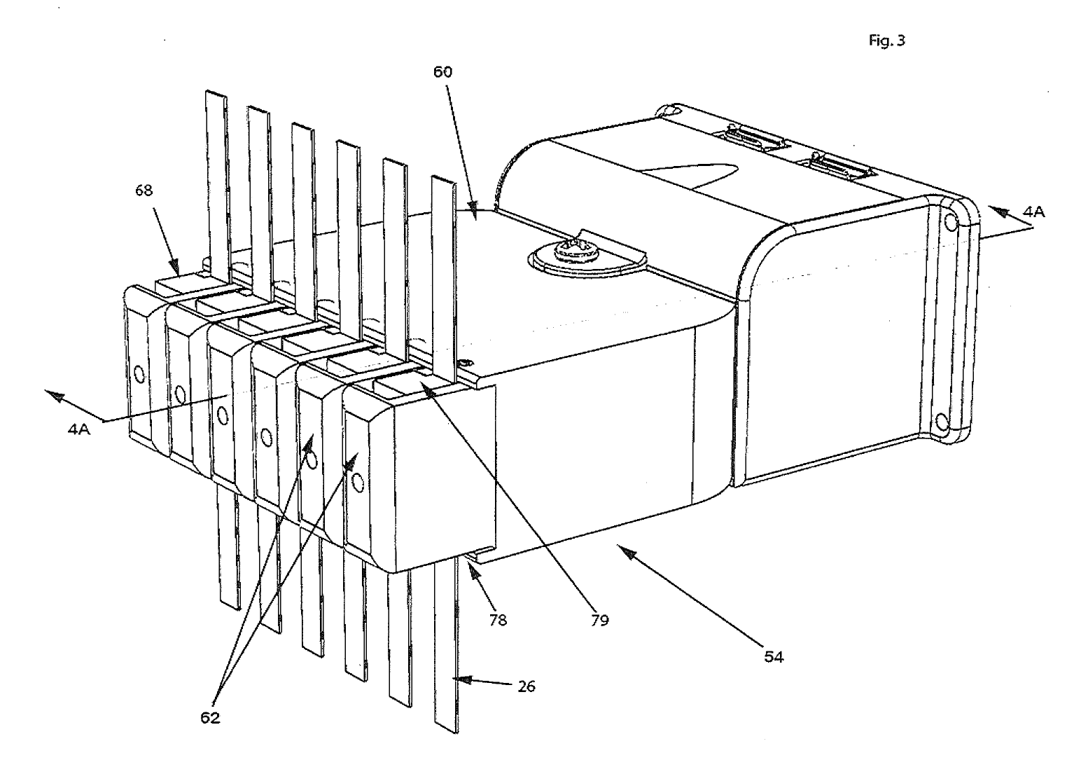

Referring to FIG. 2-3, the monitoring apparatus 50 may include a controller 52 coupled to each of an imaging assembly 54, a communication unit 56 and a power supply unit 58.

The controller 52 may include a processor 53, such as a central processing unit (CPU), and a memory 53A, such as a ROM, a solid state memory or like data storage media. The memory 53A may include instructions executable by the processor to perform functions of the present disclosure including control of operation of and exchange of data with components of the apparatus 50, as described herein. In addition, the controller 52 may control exchange of data with a component external to the monitoring apparatus 50.

The communication unit 56 may include components (not shown) that can provide for wired or wireless communication of data, under control of the controller 52.

The power supply unit 58 may include a battery 90 that stores energy for powering components of the assembly 50, and a solar energy generating unit 92. The solar unit 60 may include a photo-voltaic cell and electronic circuits for storing electrical power generated in the photo-voltage cell in the battery 90. In another embodiment, the power supply unit 58 may include electronic circuitry for converting conventional AC power into electrical power, such as DC power, suitable for powering the components of the apparatus 50.

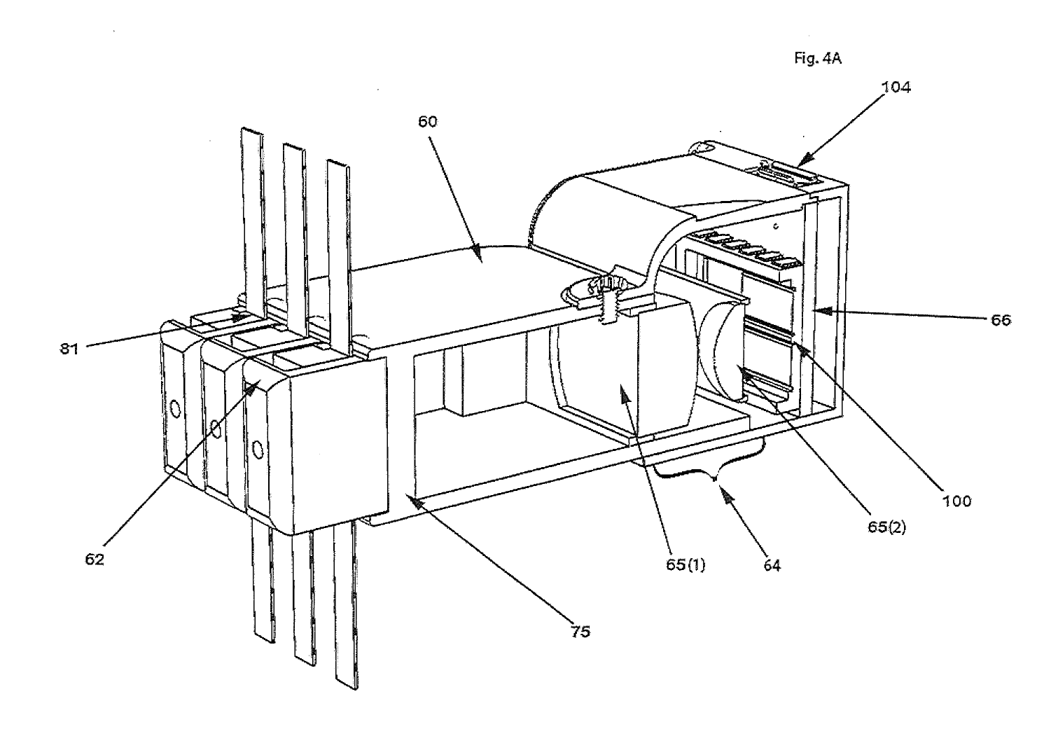

Referring to FIGS. 3, 4A and 4B, the imaging assembly may be configured in the form of a housing 60 including optical fiber ribbon fixtures 62, a lens unit 64 and an imaging unit 66.

The imaging unit 66 includes an array 100 of photo-detectors or photo-sensitive elements for generating image data based on detected light, and electronic circuitry 102 for transferring the image data via power and bi-directional data connectors 104, such as a USB connector, to the controller 52. In one embodiment, the electronic circuitry 102 may be configured such that power from the power supply unit 58 may be supplied through cables, such as USB cables (not shown), that interconnect multiple imaging assemblies 54 to one another, via the connectors 104 thereof, or to the controller 52, in a daisy-chained connection configuration, where the interconnected imaging assemblies 54 collectively form the imaging assembly of the monitoring apparatus 50. In addition, the electronic circuitry 102 may be configured to transmit to the controller 52, over the power and data cables connected to the connectors 104 of respective imaging assemblies, image data generated respectively therein or by another of the imaging assemblies, in accordance with control instructions received from the controller 52 over the cables.

The array 100, as discussed in detail below, may be in the form of a linear, one-dimensional array of photo-sensors (pixels), or a two-dimensional array of photo-sensors. The pixels may generate image data representative of an amount of light collected at the pixels over a predetermined time interval.

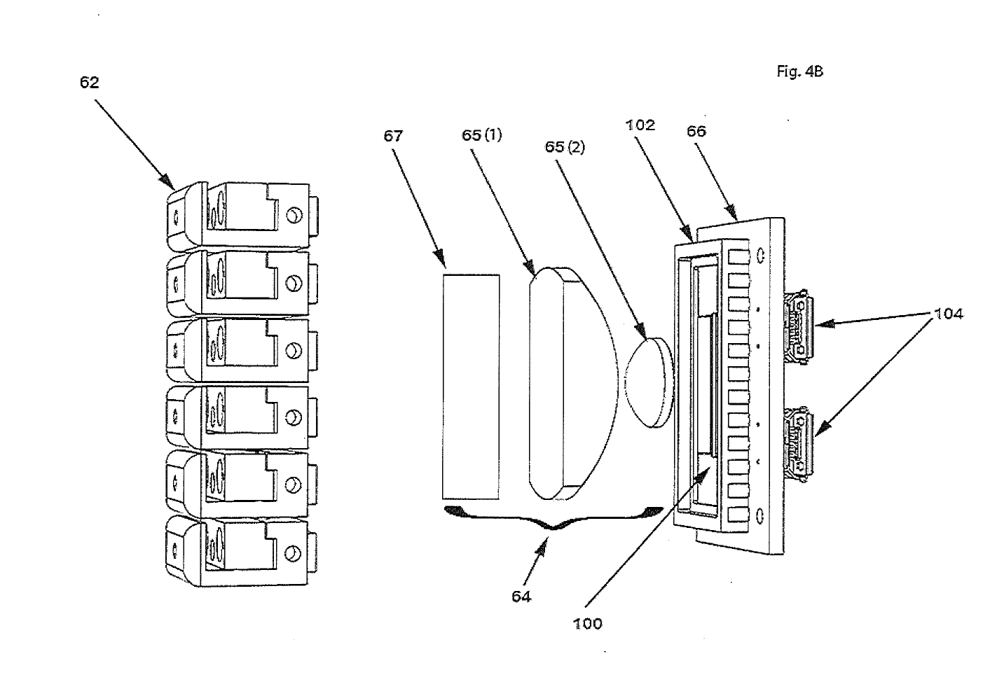

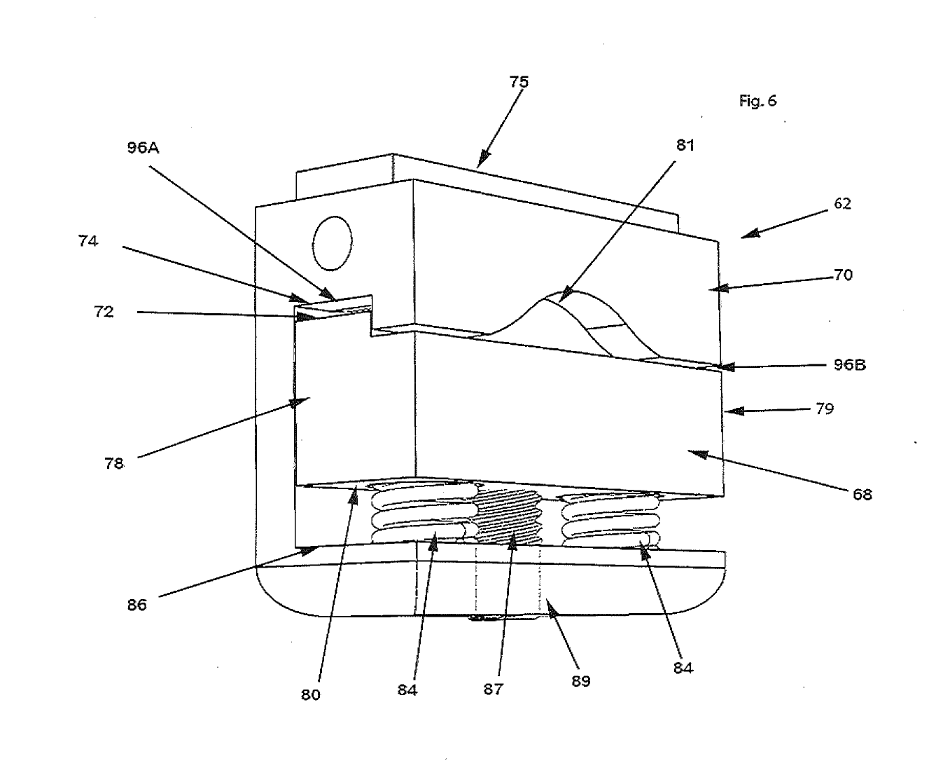

Further referring to FIGS. 5, 6 and 7, a ribbon fixture 62 of the apparatus 50 may include a bottom plate 68 and a top plate 70 opposite the bottom plate 68 having respective surfaces 72 and 74 facing each other. The surface 72 may include an arcuately projecting surface portion 76 extending between opposing ends 78 and 79 of the fixture 62. Referring to FIGS. 4A, 6 and 7, an upper covering 75 of the fixture 12 defines an aperture 83 that exposes only a portion 81 of the arcuate surface portion 76 to a lens element 65 of the lens unit 64. The portion 81 is generally at an apex portion of the arcuate surface portion 76 that is closest to the top plate 70.

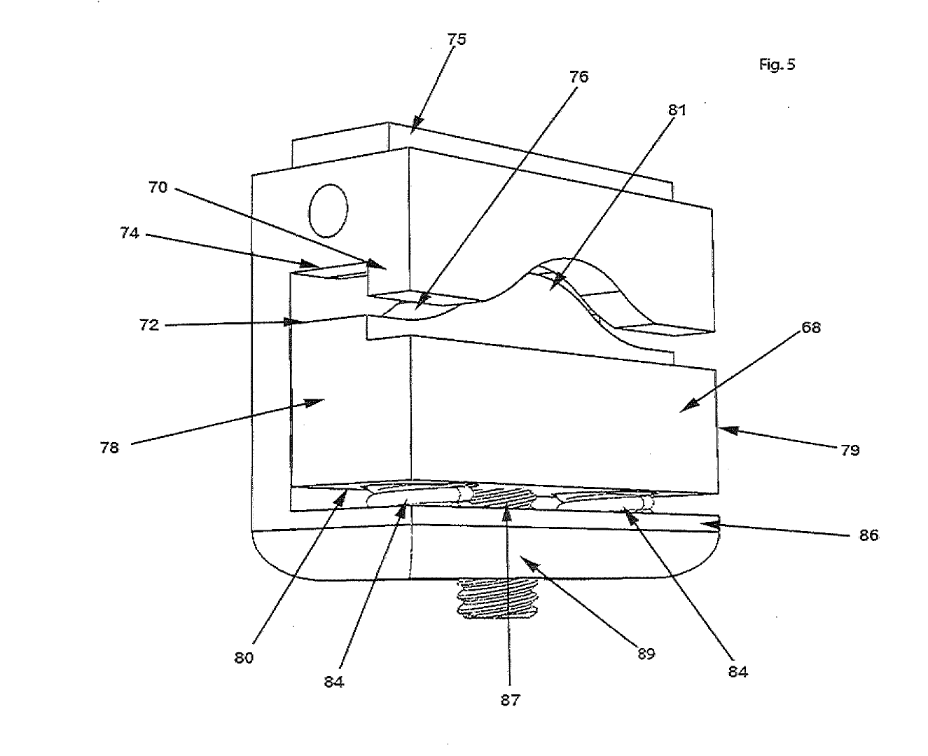

Referring to FIGS. 5 and 6, springs 84 couple the bottom plate 68 at a surface 80, which is opposite to the surface 72, to a base 86 of the fixture 62, and a rod 87 fixed at one end to the surface 80 is movable through an aperture 89 extending through the base 86. The springs 84 normally bias the bottom plate 68 toward the top plate 70 to place the fixture 62 in a ribbon holding state, as shown in FIG. 6, where the rod 87 may extend at least partially through the aperture 89. The bottom plate 68 is movable away from the top plate 70 to switch the fixture from the holding state to a fiber ribbon receiving state, by applying a force to the bottom plate 68 in the direction of the base 86, which causes the springs 84 to compress and the rod 87 to move further into the aperture 89 away from the top plate 70. The surfaces 72 and 74 are configured such that, when the fixture 62 is in the ribbon holding state, an optical fiber ribbon, such as the ribbon 26 (see FIG. 3), extending along the surface 72 from the end 78 to the end 79 is held fixed in position within the fixture 12 at channels 96A and 96B defined between the surfaces 72 and 74 at the ends 78 and 79, respectively.

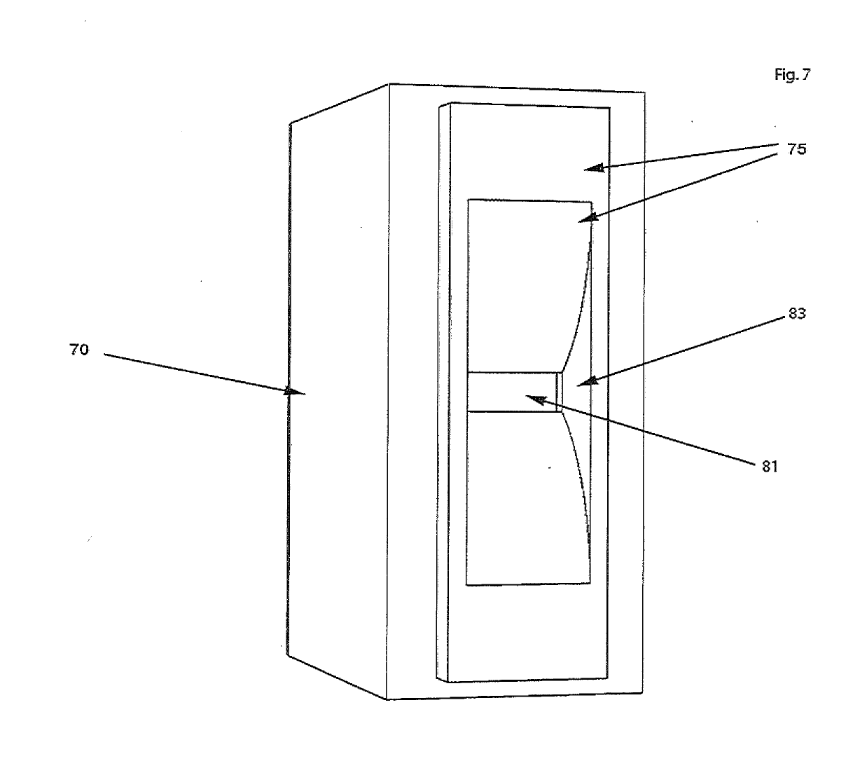

Referring to FIG. 8A, the arcuate surface portion 76 may introduce a predetermined bend in optical fibers 28 of an optical fiber ribbon 26 that is positioned extending along the surface 72 from the end 78 to the end 79 of the fixture 62 and is held between the plate 68 and the plate 70 (not shown) when the fixture 62 is in the ribbon holding state. The configuration of the surface portion 76 desirably introduces a radius of curvature to the fibers of the ribbon that may cause a portion of light propagating in the fibers of the ribbon to escape out of the fibers. Referring to FIG. 4B, the lens unit 64 may include lens elements 65(1) and 65(2) positioned relative to the fixture 62 and the array 100, and having a geometry and refractive properties, such that, when the fiber ribbon is held by the fixture 62 as illustrated in FIG. 8A, the light scattering out of the fibers, which is caused by the bend introduced to the fibers, is focused by the lens elements 65 onto the array 100.

In an exemplary implementation of the apparatus 50, optical fiber ribbons 26 may be held in a bent configuration in respective fixtures 62 (see FIG. 3), such that a bent portion of the fibers 28 of the ribbons faces the lens elements 65 of the lens unit 64. Light from optical signals transmitted through the respective fibers of the ribbons is caused to escape out of the fibers at the bent portion of the fixtures 12. The light that escapes out of the fibers at the portion 81 of the fixture 12 is focused by the lens elements so as to be detected by the photo-sensitive elements (pixels) of the array 100. The pixels are read at an exposure time interval, to obtain image data representative of an image corresponding to the light caused to escape out of the fibers at the bent portion of the fibers which is detected at the array.

Referring to FIGS. 1 and 8A, in an exemplary operation of the PON 10, light may propagate in the fibers 28 in an upstream direction U, based on transmission of optical signals from ONTs 18 that are coupled to a downstream side of the fibers 28. Also, light may simultaneously propagate in the fibers 28 in a downstream direction D, which is opposite to the direction U, based on transmission of optical signals from the head end 12 that is coupled to an upstream side of the fibers 28. In such circumstances, light escaping out of the fibers at the fixture 12 may include a portion of the light propagating in each of the upstream and downstream directions. In a typical PON 10, the light propagating in the upstream and downstream directions are of different wavelengths. As discussed below, in one embodiment a connection arrangement between the fibers 28 and the ONTs 18 may be determined based on detection of an amount of light escaping out of the fibers that is a portion of the light propagating in the direction U. Detection at the array 100 of a portion of the light that is from the light propagating in the direction D may cause errors in the determination of the connection arrangement, and therefore is avoided in desired embodiments of the monitoring apparatus 50.

In one embodiment, the positioning and construction of lens element(s) 65 of the lens unit 64, the array 100 and the fixture 12 may be adapted such that detection at the array of escaping light from the fibers that is other than escaping light that is a portion of the light propagating in the direction U is avoided. For example, the positioning and construction of the elements of the apparatus 50 may provide that the escaping light other than from the light in the direction U is not focused upon the photo-detectors of the array.

In another embodiment, the imaging assembly 54, for example, the lens unit 64 thereof, may include an optical wavelength filter 66 that passes only light having predetermined wavelengths that correspond to the wavelengths of light used for optical signal transmission in the direction U from the ONTs 18. The filter 66 may be placed anywhere in a path over which escaping light from a fiber held at the fixture 12 may travel from the aperture 81 of the fixture to the array 100. The filter 66 does not pass light of a wavelength of the optical signals transmitted in the direction D and, thus, avoids light that is other than a portion of the light propagating in the upstream direction U from being detected at the array 100. Accordingly, based on use in the monitoring apparatus 50 of at least one of the filter 66 or a predetermined arrangement and structures of the fixture, array and lens elements, detection at the array of escaping light other than from portions of light propagating in the direction U may be avoided.

Referring to FIGS. 4B, 8A and 11, the lens unit 64 and the fixture 62 may be arranged in relation to the array 100 such that escaping light L, where “L” is a portion of the light propagating in the U direction as indicated in FIG. 8A, from a particular fiber 28 extending along a particular region R of the surface 76 can impinge only upon a predetermined pixel or pixels of the array 100. In other words, the particular region R of the surface 76 upon which a fiber 28i of the ribbon 26 extends determines the pixel or pixels Pi that may detect light caused to escape out of the fiber 28i. For example, only the light L1 escaping out of a fiber 28₁ extending along a region R1 of the surface 76 can be detected at a particular pixel or pixels Pi of the array 100. Any other light L escaping out of fibers other than fiber 28₁ is focused so as not to be detected at the Pi, or so that only a nominal, insignificant amount thereof may be detected at a pixel other than the pixel Pi. Accordingly, there is a predetermined correspondence between detection of escaping light at a particular pixel(s) of the array of the apparatus 50 and the fiber at the fixture that is the source of the escaping light detected at the particular pixel(s) of the array. Consequently, the detection of light at a particular pixel(s) is representative of transmission of optical signals through a single, predetermined fiber 28i of the fibers 28.

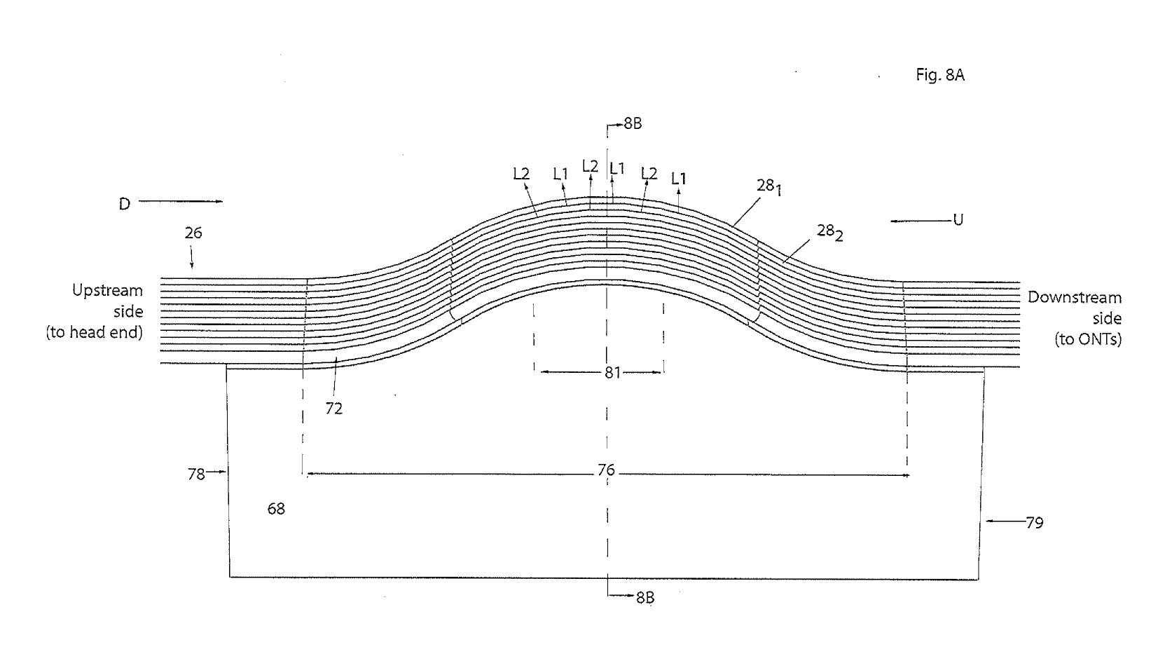

Referring to FIGS. 4B, 8A, 8B, 9 and 11, in one embodiment, the array 100 may be a linear, one-dimensional array 100A of pixels P1-P8 arranged to extend in a direction orthogonal to the direction the fibers 28 of the ribbon 26 longitudinally extend along the surface 72 of the fixture 62 when the ribbon 26 is held in the fixture 12. In such embodiment, for example, the light L1 escaping out of the fiber 28₁, which is positioned extending along the longitudinal region R1 at the portion 81 of the surface 76, is focused by the lens elements 65 to impinge only upon the pixel P1. In addition, the light L2 escaping out of the fiber 28₂, which is positioned extending along the longitudinal region R2, is focused by the lens 65 to impinge only upon the pixel P2. Similarly, the light L3 to L8 escaping out of the fibers 28₃ to 28₈ extending along the regions R3 to R8, respectively, is focused to impinge only upon the pixels P3-P8.

Light detected at the respective pixels P of the array 100A is collected for a predetermined exposure or detection time interval, after which the pixels are read out by the electronic circuitry 102 of the imaging unit 66 to generate image data representative of the amount of light collected during the detection interval by the respective pixels. The imaging unit supplies the image data to the controller 52 via the connector 104 and cables (not shown). The image data may desirably correspond to images, sequentially obtained, based on detection of light escaping from the portions of the fibers of the ribbon 26 at the surface portion 81, passing through the aperture 83 and focused by the lens unit 64 (as schematically illustrated in FIG. 8B) onto the pixels P of the array. The image data may indicate, for each pixel P, a value of a brightness characteristic that is in accordance with an amount of escaping light of a fiber 28i detected at the corresponding pixel Pi during a detection interval and, thus, represents whether transmission of an optical signal in the direction U occurs through the fiber 28i of the fibers 28 corresponding to the pixel Pi during the detection interval. For example, a high value for the brightness characteristic of pixel P1 of the array 100A represents optical signal transmission in the direction U occurs through the optical fiber 28₁ during the detection interval, whereas a zero or nominal value for the brightness characteristic of the pixel P1 represents that optical signal transmission through the optical fiber 28₁ in the direction U does not occur during the detection interval. The detection interval, for example, may be milliseconds or microseconds.

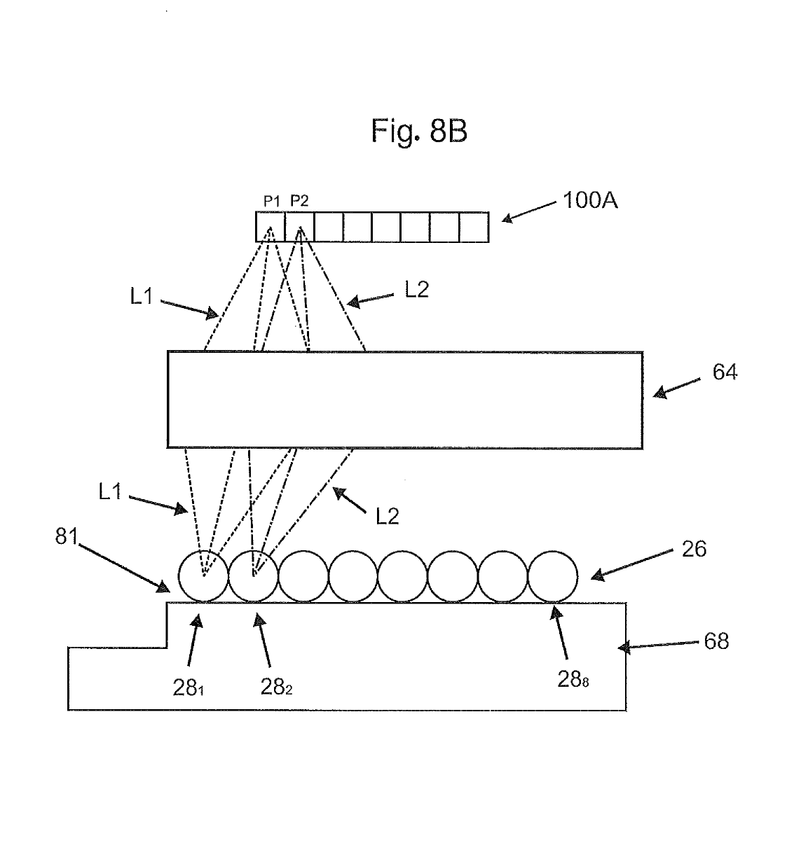

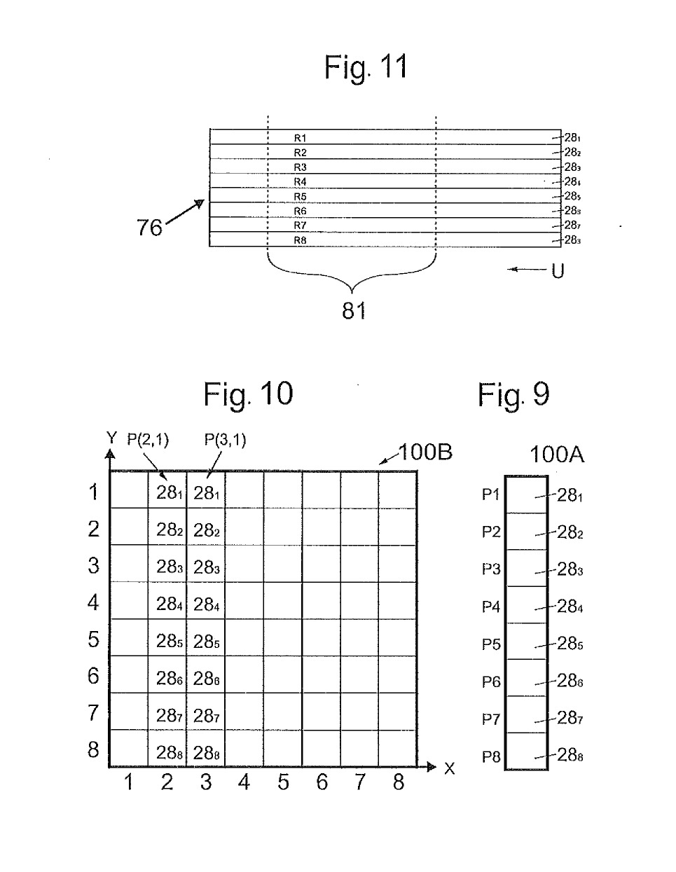

Referring to FIG. 10, in another embodiment, the array 100 may be a two-dimensional array 100B of 64 pixels P(1,1) . . . P(8,8). The array 100B and the lens elements 65 may be configured such that light L1 escaping out of the fiber 28₁, which is positioned extending along the region R1 (see FIG. 11), is focused to impinge only upon the pixels P(2,1) and P(3,1). In addition, light L2 escaping out of the fiber 28₂, which is positioned extending along the region R2, is focused to impinge only upon the pixels P(2,2) and P(3,2). Similarly, light L3, L4 . . . , and L8 escaping out of the fibers 28₃, 28₄, . . . and 28₈ extending along the regions R3, R4, . . . and R8, respectively, is focused to impinge only upon the pixels P(2,3) and P(3,3), P(2,4) and P(3,4), . . . and P(2,8) and P(3,8).

The controller 52 may control imaging at the imaging assembly 54, so that image data for a plurality of consecutive detection intervals is obtained for each of the pixels. The image data for the consecutive detection intervals constitutes image data of a monitoring interval. The generation of image data for a monitoring interval may be controlled by the controller 52, in accordance with instructions received at the communication unit 56 over a communication network. The instructions, for example, may be from a network operation center (NOC) which is connected to the head end 12, and also instruct that the image data for a monitoring interval be streamed over a communication network to an identified destination, such as a fiber connection path identification device 160 as described below.

In one embodiment, the instructions received at the apparatus 50 may cause the controller 52 to control the imaging assembly 54 to generate image data at same predetermined times when throughput data for respective ONTs 18 is collected, such at the head end 12 or a NOC. Throughput data indicates an amount of data received at the head end 12 that results from optical signal transmission of data from an ONT 18i to the head end 12 over an optical fiber connection path which includes a fiber 30i, a fiber 28i, a fiber 23i and the fiber 20 and, thus, interconnects the ONT 18i with the head end 12.

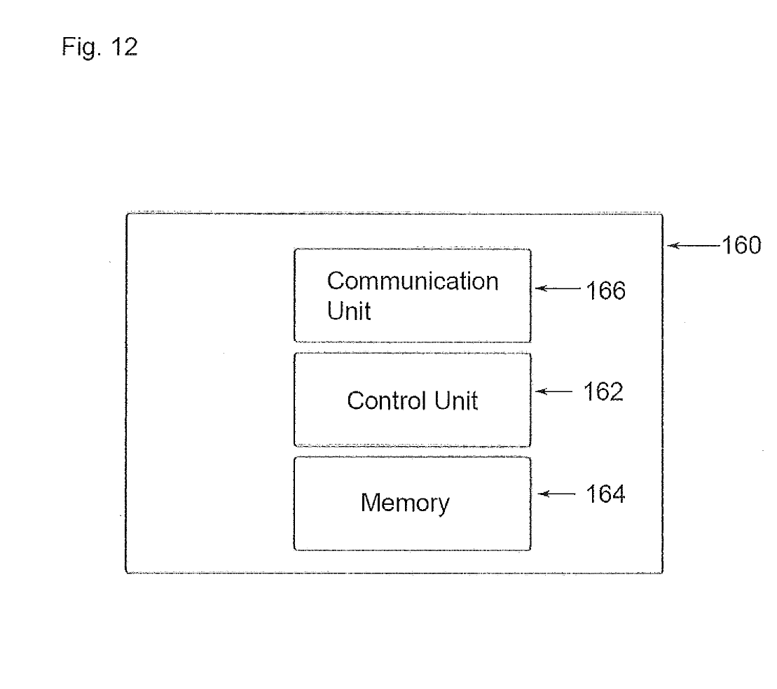

Referring to FIG. 12, a fiber connection path identification unit 160 that determines connection paths between respective fibers 28 and ONTs 18 of the PON 12, based on the imaging data generated at the monitoring apparatus 50, may be implemented at the head end 12, as in the illustrated embodiment (see FIG. 1), or alternatively at a NOC or another location. The path identification unit 160 may include a control unit 162 containing a processing unit (CPU) (not shown) connected to a memory 164 and a communication unit 166. The communication unit 166 has similar operating features as the communication unit 56. The processor of the control unit 162 may perform instructions, which are stored in the memory 164, to determine from image data generated by the monitoring apparatus 50 and throughput data identified as associated with respective ONTs 18, the identity of the fibers of the fibers 28 of the ribbons 26 of the PON 10 that are connected to respective ONTs 18. The throughput data desirably indicates an amount of data transmitted by a particular ONT over a predefined monitoring interval, such as a ten minute interval beginning at a particular time of day, such as 11:00 pm.

In one embodiment, the throughput data may represent predetermined optical signal transmissions of data by an ONT 18, which the ONT performs during a predetermined monitoring interval based on predetermined instructions that control operation of the ONT 18. For example, the predetermined instructions may cause the ONT 18 to transmit optical signals to the head end 12 for a specified portion of a monitoring interval which begins at 4:00 am.

In another embodiment, a bandwidth usage monitor 150 may be implemented at the head end 12 (see FIG. 1) and be adapted to operate to generate throughput data representative of optical signal transmission by the respective ONTs 18 over the fiber 20. In one embodiment, the monitor 150 may be a part of the identification unit 160.

At the monitor 150, a processor (not shown) may suitably receive communication data carried by optical signals transmitted by the respective ONTs 18 to the head end 12. The communication data is identified with a media access control (MAC) address that uniquely identifies the ONT 18 that transmitted the communication data. The monitor 150, using the MAC address associated with the communication data, generates and stores in a memory (not shown) throughput data indicating an amount of data transmitted by optical signal transmission from a particular ONT during a monitoring interval. The throughput data, hence, may be used to generate a value indicating an average throughput data level at the head end 12 based on optical signal transmission by a particular ONT over the monitoring interval.

In one embodiment, the throughput data may correspond to optical signal transmission by an ONT 18 performed on demand by a user, in other words, based on ordinary operation of the ONT by a user to transmit communication data, such an Internet search request, over the network 10 during a predetermined monitoring interval. In such operation, the ONT 18 transmits optical signals independent of any control on operation of the ONT for transmission of optical signals over the network 10.

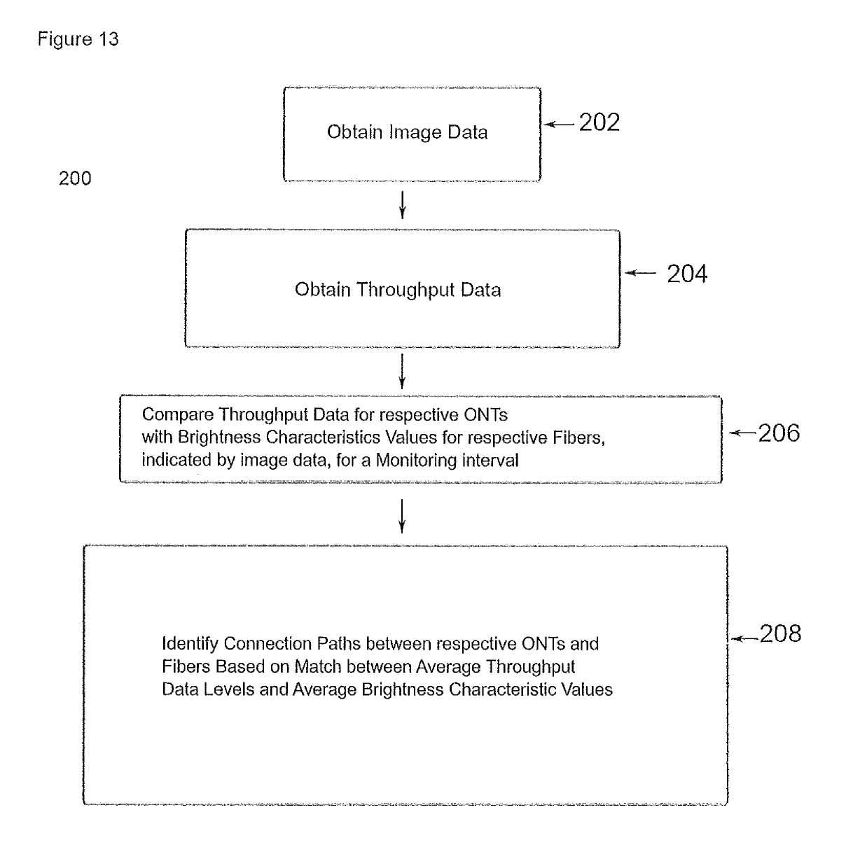

The control unit 162 of the identification unit 160 may perform a method 200 as shown in FIG. 13 to determine a connection path arrangement between fibers of optical fiber ribbons and respective ONTs of the network 10, which identifies the fibers 28 to which respective ONTs 18 are coupled.

Referring to FIG. 12, in block 202 the control unit 162 may cause transmission to the monitoring apparatus 50, via the communication unit 166, of a request for image data. Based on the request, the monitoring apparatus 50 generates, and transmits via the communication unit 56 to the identification unit 160, image data representative of detection of upstream optical signal transmission through respective fibers 28 of the ribbons 26 during a monitoring interval specified in the request.

In block 204, the control unit 162 may obtain throughput data for the ONTs 18 for the same monitoring interval specified in the request of block 202. The throughput data may be obtained, for example, from the bandwidth monitor 150 or from another device over the PON or another communication network.

In block 206, the control unit 162 may determine connection information that indicates connection paths between respective ones of the fibers 28 and respective ones of the ONTs 18, based on the image data and throughput data obtained, respectively, in blocks 202 and 204. In one embodiment, throughput data levels for respective ONTs 18, as indicated by the throughput data, and brightness characteristic values that are based on detection of optical energy at the pixels P of the array 100 from the light escaping out of the respective fibers, which represent whether optical signal transmission is occurring for the respective fibers and are indicated by the image data, are compared for a predetermined monitoring interval, to determine a match or substantial correlation between throughput data levels for respective ONTs 18 and brightness characteristic values for respective fibers 28 during the monitoring interval.

In one embodiment, the control unit 162, for a predetermined monitoring interval, determines an average brightness characteristic value detected for each of the fibers represented in the image data, and then determines ratios of average detected brightness characteristic values for pairs of the fibers. For example, where the image data indicates that optical power is detected at a pixel of the array, which can detect only light caused to escape out of a fiber 28₁, for a period equal to 10% of the monitoring interval, and that optical power is detected at a pixel of the array, which can detect only light caused to escape out of a fiber 28₂, for a period equal to 50% of the monitoring interval, the ratio of the average detected brightness characteristic values of the fiber 28₂ to the fiber 28₁ is 5:1 for the monitoring interval. In addition, the control unit 162, for the same monitoring interval, determines, from the throughput data, average throughput data levels for each of the ONTs 18, and then determines ratios of average throughput data level for respective pairs of the ONTs. For example, where the throughput data indicates that an amount of throughput data for an ONT 18₁ is equal to 10% of the maximum possible throughput data for the monitoring interval, and that the amount of throughput data for an ONT 18₂ is equal to 50% of the maximum possible throughput data for the monitoring interval, the ratio of the average throughput data levels of the ONT 18₂ to the ONT 18₁ is 5:1 for the monitoring interval.

The control unit 162 compares the ratios of average throughput data levels for respective pairs of the ONTs 19 with the ratios of average brightness characteristic values for respective pairs of the fibers 28, to determine a match or substantial correlation between the former and the latter. When a match or substantial correlation is determined, block 208 is executed.

In block 208, the control unit 162 may generate connection information that identifies the pairs of fibers and pairs of ONTs whose respective ratios of average brightness characteristic values and average throughput data levels match. For the example indicated above, the connection information may indicate that the ONT 18₂ is coupled to the fiber 28₂ and the ONT 18₁ is coupled to the fiber 28₁, based on the matching of the respective ratios of 5:1. The connection information, thus, identifies connection paths between fibers 28 in the hub 14 and respective ONTs 18. Further, the control unit 162 in block 208 may control transmission of the connection information via the communication unit 166 to another communication device, which may include communication of the connection information over a communication network including the PON 10.

It is to be understood that the control unit 162 may perform the process 200 so as to compare patterns of throughput data levels for all of the ONTs 18 with patterns of optical signal power detection for all of the fibers 28 as represented by brightness values indicated by the image data, such that connection information is generated that identifies all existing connection paths in the PON 10 between fibers 28 of the ribbons 26 and respective ONTs 18.

Based on the connection information, in the event a service problem is reported for the PON 10 in connection with a particular ONT 18i, the fiber 28i which is coupled to the ONT 18i is known and repair efforts can be easily instituted to address the problem which, for example, may exist at the fiber 28i or a connection thereto. For example, a technician may, by using such connection information for the PON 10, repair the problem reported for the ONTi by, at the panel unit 16, disconnecting a fiber 30, which is coupled to the connector jack numbered with a number that corresponds to the fiber 28i, and connecting the disconnected fiber 30 to the connector jack numbered with a number corresponding to another fiber 28j at the panel unit 16. Advantageously, based on the connection information which includes numbering information for the respective fibers 28, the specific fiber 28i connected to the ONT 18i is known and, thus, a particular fiber 30i connected at the panel unit 16 that extends from the ONT 18i is known, because the fiber 30i is connected at the panel unit 16 with a connector jack identified with a same number that is used to identify the fiber 28i. Hence, an ONT 18 other than the ONT 18i is avoided from being inadvertently disconnected from the panel unit 16.

In one embodiment, the optical power level of an optical signal transmitted from an ONT 18 may be selectively modulated, in accordance with a predetermined instruction, such as provided from the unit 160, so as to lower the optical signal power level relative to an ordinary operating power level. Based on such operation, the image data generated at the monitoring apparatus 50 may indicate such modulation of the power level on a particular fiber 28, based on the corresponding changes in the amount of escaping light from the particular fiber detected at the array, such that the particular ONT 18 at which the optical signal power is modulated may be identified. As such, the power level of the optical signal transmitted from the respective ONTs may be modulated individually in sequence, so that individual optical fibers of the ribbon may be identified based on their position within an image using the image data, which indicates a pattern of positions within an image at which escaping light corresponding to the modulated optical signals from respective fibers is detected.

In one embodiment, the control unit 162 may determine from the brightness characteristic values included in the image data whether there is a drop, and also an amount of a drop, in the optical power level of an optical signal being conveyed in a particular optical fiber of the ribbons, and if there is a drop, whether the drop exceeds a predetermined threshold. For example, an alarm threshold may be set such that if a determination is the detected power level is below a predetermined level continuously for a predetermined time interval, such as five minutes, a drop alarm indication is generated.

In another embodiment, the control unit 162 may determine from the brightness characteristic values indicated by the image data, whether an optical power level transmitted for a particular ONT 18, which is indicated to correspond to a particular fiber 28 by the connection information obtained in accordance with the present disclosure, recovers to above a threshold after it is detected to be below the threshold.

In another embodiment, the control unit 162 may determine, from the image data generated at the monitoring apparatus 50, whether there is a partial or complete loss of an optical signal transmitted in any of the optical fibers in the ribbon, based on expected predetermined operation of ONTs during a monitoring interval and the connection information obtained in accordance with the present disclosure.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

1. An apparatus for monitoring optical signal transmission in a plurality of optical fibers, the apparatus comprising:
a fixture for introducing a bend into the plurality of fibers arranged at respective predetermined locations on the fixture, to cause a portion of light propagating in any of the fibers to scatter out therefrom; and
an imaging assembly including a lens unit and an imaging unit containing an array of photo-detectors,
wherein the lens unit is positioned to focus the scattered light onto predetermined photo-detectors of the array, in accordance with the fiber from which the scattered light emanates,
wherein the imaging unit generates image data indicating a characteristic of the scattered light detected at respective ones of the photo-detectors identified by location in the array corresponding to the respective ones of the photo-detectors.

2. The apparatus of claim 1 further comprising:
a control unit to control imaging of the scattered light from the optical fibers by the imaging unit, in accordance with an instruction received at the apparatus over a communication network.

3. The apparatus of claim 1, wherein the array is a linear, one-dimensional array.

4. The apparatus of claim 1, wherein the array is a two-dimensional array.

5. The apparatus of claim 1, wherein the imaging unit is configured such that light detected at the array is substantially from light propagating in a single longitudinal direction along one or more of the fibers.

6. The apparatus of claim 5, wherein the imaging assembly includes an optical filter positioned to pass only light of a predetermined wavelength range to the array, wherein the predetermined wavelength range includes a wavelength of the light propagating in the single direction.

7. The apparatus of claim 5, wherein the array, a lens element of the lens unit that focuses the scattered light onto the array and the fixture are positioned at predetermined positions such that the light detected at the array is substantially the light propagating in the single direction.

8. The apparatus of claim 1, wherein the image data indicates a brightness characteristic of the detected light.

9. A method for monitoring optical signal transmission in a plurality of optical fibers, the method comprising:
introducing a bend into the plurality of fibers arranged at respective predetermined locations on a fixture, to cause a portion of light propagating in any of the fibers to scatter out therefrom;
focusing the scattered light onto predetermined photo-detectors of an array of photo-detectors, in accordance with the fiber from which the scattered light emanates; and
generating image data indicating a characteristic of the scattered light detected at respective ones of the photo-detectors identified by location in the array corresponding to the respective ones of the photo-detectors.

10. The method of claim 9 further comprising:
transmitting the image data over a communication network, wherein the generating and transmitting of the image data is in accordance with an instruction received over the communication network.

11. The method of claim 9 further comprising:
generating connection information indicating connection paths between respective ones of the fibers and ones of optical signal transmission units, based on the image data and throughput data identified as corresponding respectively to the optical signal transmission units.

12. The method of claim 9, wherein the throughput data for at least one of the optical signal transmission units is a predetermined average throughput value.

13. The method of claim 9, wherein the throughput data for at least one of the optical signal transmission units is determined based on monitoring of throughput data identified by a MAC address corresponding to the one optical signal transmission unit.

14. The method of claim 9, wherein the array is a linear, one-dimensional array.

15. The method of claim 9, wherein the array is a two-dimensional array.

16. The method of claim 9, wherein light detected at the array is substantially from light propagating in a single longitudinal direction along one or more of the fibers.

17. The method of claim 9, wherein only light of a predetermined wavelength range is passed to the array, wherein the predetermined wavelength range includes a wavelength of the light propagating in the single direction.

18. The method of claim 9, wherein the array, a lens element of that focuses the scattered light onto the array and the fixture are positioned at predetermined positions such that the light detected at the array is substantially the light propagating in the single direction.

19. The method of claim 1, wherein the image data indicates a brightness characteristic of the detected light.
